(19) United States
(12) Patent Application Publication
(10) Pub. No.: US 2020/0314606 A1
(43) Pub. Date: Oct. 1, 2020

(54) Sensor Cloud Architecture for Moisture Detection

(71) Applicant: G2i Incorporated, Palo Alto, CA (US)

(72) Inventors: Thomas Reed Stevens, Palo Alto, CA (US); Suguru Nishioka, San Francisco, CA (US); Ivan J. Goering, Palo Alto, CA (US)

(21) Appl. No.: 16/365,372

(22) Filed: Mar. 26, 2019

(51) Int. Cl. H04W 4/38; A41D 1/00; G08B 21/18; G08B 21/20; G08B 27/00

(52) U.S. Cl. CPC H04W 4/38; A41D 1/002; G08B 27/005; G08B 21/20; G08B 21/182

(57) ABSTRACT

A cloud-implemented system, device, product, apparatus, and/or method for limiting wetness exposure time in an absorbent garment by providing sensor data from a sensor system including one or more absorbent garments, one or more sensors, and/or one or more processors, and receiving, by a sensor cloud, sensor data associated with one or more sensors. The method for authenticating in response to receiving sensor data, at least one attribute by correlating at least one attribute to data in a sensor cloud, validating a status of an absorbent garment based on sensor data remaining consistent for a measured period of time, and generating an action to limit wetness exposure time in an absorbent garment based on a status of an absorbent garment.

### BACKGROUND OF THE INVENTION

### Field of the Invention

The present disclosure relates generally to a cloud of monitoring devices, systems, and methods for detecting and reducing wetness exposure time in an absorbent garment. More particularly, the present disclosure relates to monitoring devices, systems, and methods for detecting and limiting wetness exposure time in an absorbent garment for tracking patient incontinence and prioritizing related care.

### Description of Related Art

Incontinence in a patient care environment is a growing problem in patient care and homecare of elderly patients. Urinary Incontinence (UI) is the involuntary leakage of urine. It is common for nursing homes and hospitals to lack the staff and financial resources to provide residents with sufficiently frequent toileting assistance. Use of special undergarments and absorbent pads or catheterization is the usual practice, however with limited assistance, patients may wait in a garment for help to change, causing long-term exposure to wetness (e.g., a wet bed, wet underwear, wet clothes, etc.) and significantly increasing the risk of infection.

Urinary Incontinence has been estimated to affect between 50% and 65% of nursing home residents. UI is also prevalent in the at-home aging population and is a leading factor in senior isolation and eventual institutionalization in a care facility. Incontinence is a critical deficit to activities of daily living that negatively impacts all aspects of autonomy, health, and overall well-being.

The demand for improved incontinence solutions exist at every stage in eldercare, from family caregiving through to acute care hospitalization, to control costs and health issues associated with long-term exposure to wet garments (e.g., clinical nurses and the research community report that there is clear correlation between incontinence and pressure ulcers and urinary tract infections (UTIs)). Approximately 60,000 people die each year as a direct result of pressure ulcers (e.g., skin free from exposure to urine and stool is very important in treating pressure ulcers and bedsores, etc.).

However, computer systems have not been capable nor demonstrated improvement to these costs and outcomes. For enterprise businesses and caregivers, such as acute care hospitals, incontinence is a contributor to revenue loss (e.g., $4 billion is spent on adult non-woven absorbency products in the US, $9 billion globally), as well as a key source of family dissatisfaction with said institutional providers. The sector is growing as baby boomers continue to age and live longer than their predecessors. Likewise, there is an increasing and rapidly expanding need to address urinary incontinence and other related health risks (e.g., skin sores, rashes, and infections from skin that is wet or damp, stunted or reduced wound healing, increased susceptibility to fungal infections, etc.). UTIs are a significant and common risk, and long-term exposure to wet garments considerably increases the chance of infection. Accordingly, provided are improved systems, devices, products, apparatuses, and/or methods for more efficiently detecting and addressing events related to wetness exposure time in an absorbent garment, as well as managing patient data related to wetness exposure for prioritizing the healthcare needs of multiple patients.

### SUMMARY OF THE INVENTION

According to some non-limiting embodiments or aspects, provided is a computer-implemented method comprising: providing sensor data from a sensor system including one or more absorbent garments, one or more sensors, and one or more processors; receiving, by a sensor cloud including one or more processors, sensor data associated with the one or more sensors, wherein the sensor data includes one or more events determined by a connection and an open or closed circuit in a sensor of the one or more sensors to provide a status of the absorbent garment, and wherein the sensor data includes one or more attributes; authenticating, by the sensor cloud, in response to receiving the sensor data, at least one attribute of the one or more attributes by correlating the at least one attribute to data in the sensor cloud; validating, by the sensor cloud, the status of the absorbent garment based on the sensor data remaining consistent for a measured period of time; and generating an action to limit wetness exposure time in the absorbent garment based on the status of the absorbent garment.

According to some non-limiting embodiments or aspects, provided is a wetness detection system for limiting wetness exposure time in an absorbent garment including: (a) a sensor system including one or more sensors, one or more absorbent garments, and one or more processors, the sensor system configured to: (i) transmit sensor data associated with at least one of the one or more absorbent garments having one or more sensors; (b) a sensor cloud in communication with the sensor system configured to: (i) receive sensor data associated with the one or more sensors, wherein the sensor data includes one or more events determined by a connection and an open or closed circuit in a sensor of the one or more sensors to provide a status of the absorbent garment, and wherein the sensor data includes one or more attributes; (ii) authenticate, in response to receiving the sensor data, at least one attribute of the one or more attributes by correlating the at least one attribute to data in the sensor cloud; (iii) validate the status of the absorbent garment based on the sensor data remaining consistent for a measured period of time; and (c) a monitoring system in communication with the sensor cloud, configured to: (i) generate an action to limit wetness exposure time in the absorbent garment based on a priority level of the status of the absorbent garment.

According to some non-limiting embodiments or aspects, provided is a sensor cloud method of limiting wetness exposure time in an absorbent garment including: receiving sensor data associated with one or more sensors associated with one or more absorbent garments, wherein the sensor data includes one or more events determined by a connection and an open or closed circuit in a sensor of the one or more sensors to provide a status of the one or more absorbent garments, and wherein the sensor data includes one or more attributes; authenticating, by the sensor cloud in response to receiving the sensor data, at least one attribute of the one or more attributes by correlating the at least one attribute to data in the sensor cloud; validating, by the sensor cloud, the status of the one or more absorbent garments based on the sensor data remaining consistent for a measured period of time; and generating an action to limit wetness exposure time in the one or more absorbent garments based on the status of the one or more absorbent garments.

According to some non-limiting embodiments or aspects, provided is a sensor cloud computer including: one or more processors; a communication system connected to the processor; and a pairing system to pair the transmitter to an absorbent garment. The sensor cloud computer is configured to: (i) transmit sensor data associated with at least one of the one or more absorbent garments having one or more sensors; (ii) receive sensor data associated with one or more sensors associated with one or more absorbent garments, wherein the sensor data includes one or more events determined by a connection and an open or closed circuit in a sensor of the one or more sensors to provide a status of the one or more absorbent garments, and wherein the sensor data includes one or more attributes; (iii) authenticate, by the sensor cloud in response to receiving the sensor data, at least one attribute of the one or more attributes by correlating the at least one attribute to data in the sensor cloud; (iv) validate, by the sensor cloud, the status of the one or more absorbent garments based on the sensor data remaining consistent for a measured period of time; and (v) generate an action to limit wetness exposure time in the one or more absorbent garments based on the status of the one or more absorbent garments.

According to some non-limiting embodiments or aspects, provided is a computer program product comprising at least one non-transitory computer-readable medium including program instructions that, when executed by at least one processor, cause the at least one processor to: (i) provide sensor data from a sensor system including one or more absorbent garments, one or more sensors, and one or more processors; (ii) transmit sensor data associated with at least one of the one or more absorbent garments having one or more sensors; (iii) receive sensor data associated with one or more sensors associated with one or more absorbent garments, wherein the sensor data includes one or more events determined by a connection and an open or closed circuit in a sensor of the one or more sensors to provide a status of the one or more absorbent garments, and wherein the sensor data includes one or more attributes; (iv) authenticate, by the sensor cloud in response to receiving the sensor data, at least one attribute of the one or more attributes by correlating the at least one attribute to data in the sensor cloud; (v) validate, by the sensor cloud, the status of the one or more absorbent garments based on the sensor data remaining consistent for a measured period of time; and (vi) generate an action to limit wetness exposure time in the one or more absorbent garments based on the status of the one or more absorbent garments.

The present invention is neither limited to nor defined by the above summary. Rather, reference should be made to the claims for which protection is sought with consideration of equivalents thereto.

Further non-limiting embodiments or aspects will now be described in the following numbered clauses:

Clause 1: A cloud-implemented method of limiting wetness exposure time in an absorbent garment, the method comprising: providing sensor data from a sensor system including one or more absorbent garments, one or more sensors, and one or more processors; receiving, by a sensor cloud including one or more processors, sensor data associated with the one or more sensors, wherein the sensor data includes one or more events determined by a connection and an open or closed circuit in a sensor of the one or more sensors to provide a status of the absorbent garment, and wherein the sensor data includes one or more attributes; authenticating, by the sensor cloud, in response to receiving the sensor data, at least one attribute of the one or more attributes by correlating the at least one attribute to data in the sensor cloud; validating, by the sensor cloud, the status of the absorbent garment based on the sensor data remaining consistent for a measured period of time; and generating an action to limit wetness exposure time in the absorbent garment based on the status of the absorbent garment.

Clause 2: The cloud-implemented method according to clause 1, wherein the sensor data, including the one or more events associated with the status of the absorbent garment, includes an event based on a change in the connection or circuit of the sensor system, and wherein providing sensor data further comprises: verifying, within the sensor system, the sensor data of the absorbent garment by determining the one or more events associated with the status are consistent over a predetermined period of time; modifying the sensor data to include identifying information; and transmitting the sensor data, including the status of the absorbent garment, to the sensor cloud.

Clause 3: The cloud-implemented method according to clauses 1 and 2, wherein the status comprises at least one of: a confirmed event, a condition assigned before receiving the sensor data, an event associated with a wet or dry condition of the absorbent garment, an absorbent garment connection or disconnection event, a time of an event, a zone of wetness, or a patient identifier.

Clause 4: The cloud-implemented method according to clauses 1-3, wherein the wet or dry condition of the absorbent garment includes a priority level based on the time of the confirmed event and the zone of wetness sensed within the sensor system.

Clause 5: The cloud-implemented method according to clauses 1-4, wherein the zone of wetness includes at least one of a central zone or a perimeter zone.

Clause 6: The cloud-implemented method according to clauses 1-5, wherein validating the status of the absorbent garment further comprises: determining the status of the absorbent garment is confirmed based on consistent sensor data readings for a measured period of time; generating absorbent garment information based on a confirmed status; transmitting absorbent garment information to a visual display; and storing at least one event of the one or more events from the sensor data associated with the status of the absorbent garment.

Clause 7: The cloud-implemented method according to clauses 1-6, wherein validating the status of the absorbent garment further comprises: receiving an inconsistent sensor data reading within a measured period of time; and resetting the measured period of time without transmitting the absorbent garment information based on the inconsistent sensor data reading.

Clause 8: The cloud-implemented method according to clauses 1-7, wherein generating an action to limit wetness exposure time in the absorbent garment further comprises: receiving absorbent garment information on a visual display, wherein the visual display includes information about a product type, the status of the absorbent garment, a priority level based on time elapsed and a zone of wetness, user settings, training materials, and technical support; and preparing an alert based on a priority level of the status.

Clause 9: The cloud-implemented method according to clauses 1-8, further comprising: creating a sensor system database; associating a user to the sensor system; storing sensor data associated with one or more validated statuses related to the absorbent garment; and comparing the data associated with the one or more validated statuses to create a history profile.

Clause 10: A wetness detection system for limiting wetness exposure time in an absorbent garment, the system comprising: (a) a sensor system including one or more sensors, one or more absorbent garments, and one or more processors, the sensor system configured to: (i) transmit sensor data associated with at least one of the one or more absorbent garments having one or more sensors; (b) a sensor cloud in communication with the sensor system configured to: (i) receive sensor data associated with the one or more sensors, wherein the sensor data includes one or more events determined by a connection and an open or closed circuit in a sensor of the one or more sensors to provide a status of the absorbent garment, and wherein the sensor data includes one or more attributes; (ii) authenticate, in response to receiving the sensor data, at least one attribute of the one or more attributes by correlating the at least one attribute to data in the sensor cloud; (iii) validate the status of the absorbent garment based on the sensor data remaining consistent for a measured period of time; and (c) a monitoring system in communication with the sensor cloud, configured to: (i) generate an action to limit wetness exposure time in the absorbent garment based on a priority level of the status of the absorbent garment.

Clause 11: The wetness detection system of clause 10, wherein the sensor data including the one or more events associated with the status of the absorbent garment includes an event based on a change in the connection or circuit of the sensor system, and wherein the sensor system is further configured to provide the sensor data by: verifying the sensor data of the absorbent garment by determining the one or more events associated with the status are consistent over a predetermined period of time.

Clause 12: The wetness detection system according to clauses 10 and 11, wherein the sensor system is further configured to validate the status of the absorbent garment by: determining the status of the absorbent garment is confirmed for the predetermined period of time; modifying the sensor data to include identifying information; sending the sensor data including the status of the absorbent garment after determining the status of the absorbent garment is confirmed; and storing at least one event of the one or more events from the sensor data associated with the status of the absorbent garment.

Clause 13: The wetness detection system according to clauses 10-12, wherein the sensor cloud is further configured to generate an action to limit wetness exposure time in the absorbent garment by: receiving absorbent garment information on a visual display, wherein the visual display includes information about a product type, the status of the absorbent garment, the priority level based on time elapsed and a zone of wetness, user settings, training materials, and technical support; and preparing an alert based on the priority level of the status.

Clause 14: The wetness detection system according to clauses 10-13, wherein the status comprises at least one of: a confirmed event, a condition assigned before receiving the sensor data, an event associated with a wet or dry condition of the absorbent garment, an absorbent garment connection or disconnection event, a time of an event, a zone of wetness, or a patient identifier.

Clause 15: The wetness detection system according to clauses 10-14, wherein the wet or dry condition of the absorbent garment includes the priority level based on the time of the confirmed event and the zone of wetness sensed within the sensor system.

Clause 16: The wetness detection system according to clauses 10-15, wherein the zone of wetness includes at least one of a central zone or a perimeter zone.

Clause 17: The wetness detection system according to clauses 10-16, wherein the sensor cloud is further configured to: create a sensor system database; associate a user to the sensor system; store sensor data associated with one or more validated statuses related to the absorbent garment; and compare the data associated with the one or more validated statuses to create a history profile.

Clause 18: The wetness detection system according to clauses 10-17, wherein the sensor cloud is further configured to validate the status of the absorbent garment by: receiving an inconsistent sensor data reading within the measured period of time; and resetting the measured period of time without transmitting the absorbent garment information based on the inconsistent sensor data reading.

Clause 19: A computer program product comprising at least one non-transitory computer-readable medium including program instructions that, when executed by at least one processor, cause the at least one processor to: receive sensor data associated with one or more sensors associated with one or more absorbent garments, wherein the sensor data includes one or more events determined by a connection and an open or closed circuit in a sensor of the one or more sensors to provide a status of the one or more absorbent garments, and wherein the sensor data includes one or more attributes; authenticate, by a sensor cloud in response to receiving the sensor data, at least one attribute of the one or more attributes by correlating the at least one attribute to data in the sensor cloud; validate, by the sensor cloud, the status of the one or more absorbent garments based on the sensor data remaining consistent for a measured period of time; and generate an action to limit wetness exposure time in the one or more absorbent garments based on the status of the one or more absorbent garments.

Clause 20: The computer program product of clause 19, further comprising program instructions that, when executed by the at least one processor, cause the at least one processor to generate the action to limit wetness exposure time in the absorbent garment by: receiving absorbent garment information on a visual display, wherein the visual display includes information about a product type, the status of the absorbent garment, a priority level based on time elapsed and a zone of wetness, user settings, training materials, and technical support; and preparing an alert based on the priority level of the status.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

FIG. 1A is a diagram of a non-limiting embodiment or aspect of an environment in which systems, devices, products, apparatuses, and/or methods, described herein, can be implemented;

FIG. 1B is an elevation view of an integrated sensor layout in accordance with an embodiment of the present invention;

FIG. 2 is a diagram of a non-limiting embodiment or aspect of a cloud system for limiting wetness exposure time in an absorbent garment;

FIG. 3 is a diagram of a non-limiting embodiment or aspect of components of one or more devices and/or one or more systems of FIGS. 1A, 1B, and 2;

FIG. 4 is a flowchart of a non-limiting embodiment or aspect of a process for limiting wetness exposure time in an absorbent garment; and

FIGS. 5A-5D are diagrams of an implementation of one or more processes disclosed herein.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. A computing device may be a mobile or portable computing device, a desktop computer, a server, and/or the like. Furthermore, the term “computer” may refer to any computing device that includes the necessary components to receive, process, and output data, and normally includes a display, a processor, a memory, an input device, and a network interface. A “computing system” may include one or more computing devices or computers. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.). Further, multiple computers, e.g., servers, or other computerized devices, such as one or more sensors, one or more absorbent garment, one or more transmitters, one or more gateways, and/or the like, directly or indirectly communicating in the network environment may constitute a “system” or a “computing system”.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

In care facilities today, many manual or semi-automated systems exist for the management and maintenance of patient bedding. Many care facilities have no way to determine, monitor, and schedule service and visits based on the real time and evolving needs of the patient. Often patients are left in their own urine and feces for extended periods of time, causing many health problems. This leads to increased demands for alternative, sensor and alert based incontinence solutions.

In existing systems, health problems related to incontinence may not be sufficiently addressed. By providing systems and methods where garments that are manually or semi-automatically monitored or reported during a nursing visit, such systems and methods may not sufficiently and/or accurately determine a time and frequency with which a product needs to be changed and may not accurately and/or efficiently determine variations (e.g., variations in part based on how absorbent garment is designed (e.g., a pad, diaper, pull-up, etc.), the severity of the incontinence, the extent of wetness, the number of events, etc.). Accordingly, existing computer systems may have no mechanism for determining, providing, and/or using sensor data associated with events in absorbent garments. As well, existing systems may have no capability for determining, providing, and/or using sensor data to limit patient exposure, and/or may not accurately and/or efficiently determine sufficient information for limiting exposure time to a wet garment, may not detect a status of an absorbent garment, may not detect the condition in a manner that may efficiently and/or accurately be used to measure, monitor, or store information to prevent and/or limit exposure time to a wet garment, may have no capability for determining, providing, and/or use wetness events in absorbent garments for reduction in the risk of skin breakdown and infections caused by a lack of air flow, moist conditions, and long exposure time to urine and fecal matter, and/or may not monitor user activity (e.g., heavy incontinence, night-time wetting, assistance for getting to the bathroom, etc.).

There currently exists a need for computer-implemented sensor cloud systems that manage incontinence care by tracking and monitoring patient data, which can also be easily adapted and integrated to suit individual or multiple patient care facilities.

Accordingly, there is a need to provide methods and apparatuses for improved detection of the condition of an absorbent garment, and a considerable need for sensor cloud systems with improved ability to monitor and display information that can allow a caregiver to quickly and efficiently address a patient with an acute care need.

The present disclosure provides a cloud-implemented wetness detection system for limiting wetness exposure time in an absorbent garment by electronically detecting an event associated with the garment and transmitting a priority status related to the event. This detection, which can be communicated across a network to a third-party device, eliminates the need for manual monitoring of a garment, providing a caregiver more efficient means to prioritize patient care. The collection and analysis of sensor data further presents a caregiver with the ability to determine patterns, compare timelines, and better anticipate the future needs of a patient.

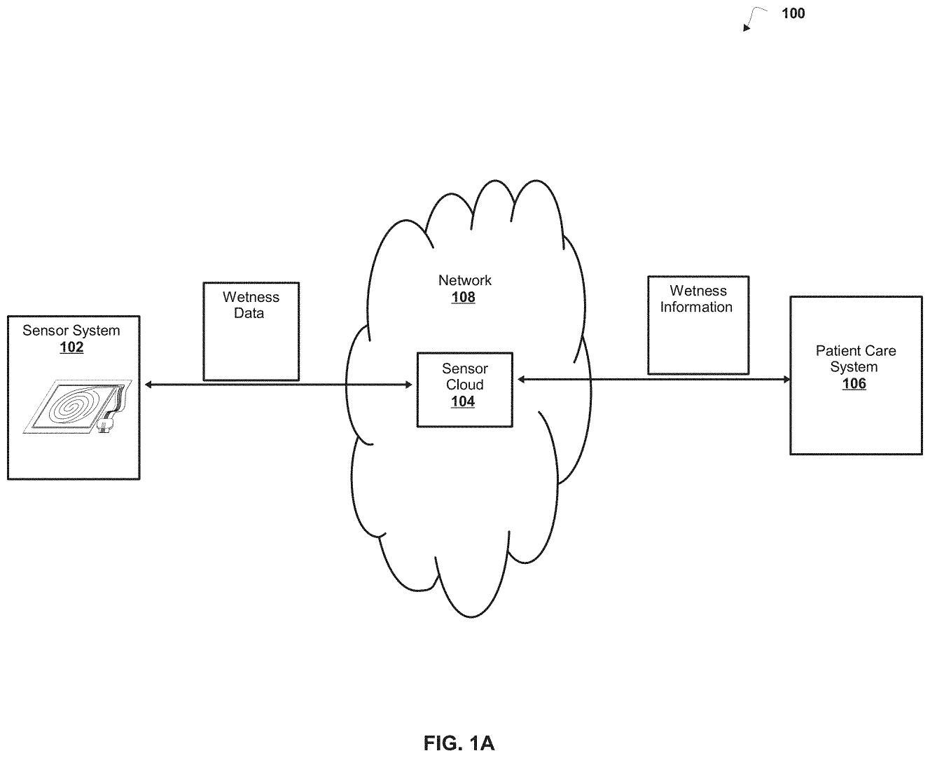

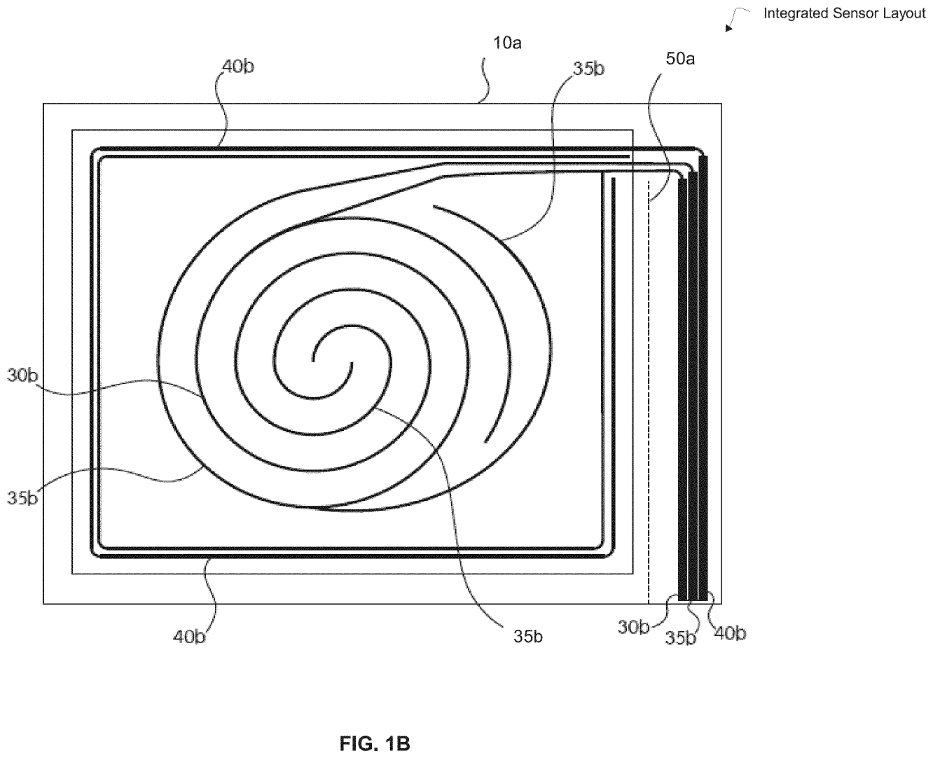

Referring now to FIG. 1A, FIG. 1A is a diagram of an example environment 100 in which devices, systems, methods, and/or products, described herein, may be implemented. As shown in FIG. 1A, environment 100 includes sensor system 102, sensor cloud 104, patient care system 106, and communication network 108. Systems and/or devices of environment 100 can interconnect via wired connections, wireless connections, or a combination of wired and wireless connections.

In some non-limiting embodiments or aspects, sensor system 102 includes one or more sensors (e.g. analog, digital, open circuit impedance, integrated sensor layout, etc.), an absorbent garment (e.g., sensor pad, briefs, diapers, pull-ups, or other wearable garments, etc.), and a transmitter which connects to the one or more sensors via a connector. In some non-limiting embodiments or aspects, sensor system 102 may store, read, detect, and generate signals (e.g., sensor data, etc.). For example, sensor system 102 detects sensor data from a sensor pad (e.g., absorbent garment with an integrated sensor system, a sensor system that is attached to an absorbent garment, etc.), and transmits sensor data defined as signals and/or messages across a network 108 (e.g., including one or more of, in any combination, internet services, cloud service, hosted or standalone computers, iPads, smartphones, databases, or other transmitters/repeaters/transceivers, etc.) to sensor cloud 104, patient care system 106, and/or the like.

In some non-limiting embodiments or aspects, sensor system 102 detects an event (e.g., wetness, moisture, urine, and/or the interacting with a sensor, a detachment of a sensor from the system, an attachment of a sensor to the system, etc.) associated with an absorbent garment (e.g., when a circuit is formed via conductive ink lines becoming wet, closed circuit, disconnection of the transmitter, etc.) and transmits the sensor data reading to the sensor cloud 104, patient care facility 106, and/or the like to validate, store, monitor, track, and communicate a status of the absorbent garment to limit wetness exposure time.

In some non-limiting embodiments or aspects, sensor cloud 104 couples with and receives sensor data from sensor system 102 for determining a status of an absorbent garment (e.g., a wet or dry condition, a connection or disconnection event, a priority level, etc.). In some non-limiting embodiments or aspects, sensor cloud 104 receives sensor data and provides absorbent garment information, for example, to the patient care system 106, and/or the like, such as any third-party care system specially programmed and/or configured to communicate via a cloud interface.

In some non-limiting embodiments or aspects, sensor cloud 104, validates a status of the absorbent garment (e.g., changes a status of an event to a confirmed event, an activity associated with a sensor, a nursing action, an activity of a patient, validates a movement of a patient, a wet or dry condition associated with a sensor, a disconnection event of the absorbent garment, etc.) based on sensor data received from sensor system 102. In some non-limiting embodiments or aspects, sensor cloud 104 validates the status of the absorbent garment based on the sensor data remaining consistent for a measured period of time (e.g., initiates a measured period for validating a status, monitors the data for 5 minutes, etc.) to generate absorbent garment information.

In some non-limiting embodiments or aspects, sensor cloud 104 authenticates one or more attributes of the sensor data by correlating the at least one attribute to data in sensor cloud 104. For example, sensor cloud 104 authenticates the received sensor data by matching one or more attributes including a transmitter identifier, a timestamp, an event associated with a wet or dry condition, an event associated with an attachment or detachment, a zone of wetness, a location identifier, and/or a patient identifier to stored data in sensor cloud 104. In some non-limiting embodiments or aspects, sensor cloud 104 logs or monitors the sensor data of one or more previous sensor data messages (e.g., sensor data previously received that may comprise one or more events associated with the one or more absorbent garments) to determine a priority level of the status of the absorbent garment.

In some non-limiting embodiments or aspects, sensor cloud 104 validates the status of an absorbent garment based on the sensor data remaining consistent for a measured period of time to generate absorbent garment information, the sensor data (e.g., at least one confirmed event, one or more attributes, etc.) including a transmitter identifier, a timestamp, or one or more previous events associated with the transmitter, may provide input for determining absorbent garment information.

In some non-limiting embodiments or aspects, patient care system 106 receives and/or communicates a priority level of a status (e.g., one or more warnings, alerts etc.) based on the validated sensor data associated with one or more residents or patients to the patient care facility staff and/or caregivers by generating absorbent garment information via a visual display interface which shows length of wetness exposure time and approximate location of wetness (e.g. zone of wetness, center wetness, perimeter wetness, etc.) allowing a caregiver to prioritize acute care needs.

In some non-limiting embodiments or aspects, patient care system 106 includes patient care facility processing systems to determine and/or provide absorbent garment information by receiving sensor data (e.g., a feed, scheduled feed, and/or streaming feed, etc.) that is continuously updated.

In some non-limiting embodiments or aspects, patient care system 106 includes patient care facility processing systems to determine and/or provide monitoring, scheduling, and replacing of wet absorbent garments based on absorbent garment information, such as, for example, by comparing absorbent garment information to sensor data reports of one or more absorbent garments (e.g., other absorbent garments in the patient care facility that are wet, etc.). In some non-limiting embodiments or aspects, patient care facility 106 compares the sensor data from a prior report of sensor data for one or more additional absorbent garments associated with a single patient, different patients, or sensor data associated with a group of patients for prioritizing each new status received. In some non-limiting embodiments or aspects, a scheduling model may determine care needs related to absorbent garment events from a plurality of prior reports of sensor data.

In some non-limiting embodiments or aspects, communication network 108 includes one or more wired and/or wireless networks. For example, communication network 108 includes a cellular network (e.g., a long-term evolution (LTE) network, a third generation (3G) network, a fourth generation (4G) network, fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks shown in FIG. 1A are provided as an example. There can be additional systems, devices, and/or networks, fewer systems, devices, and/or networks, different systems, devices, and/or networks, or differently arranged systems, devices, and/or networks than those shown in FIG. 1A. Furthermore, two or more systems or devices shown in FIG. 1A can be implemented within a single system or a single device, or a single system or a single device shown in FIG. 1A can be implemented as multiple distributed systems or devices. Additionally, or alternatively, a set of systems or a set of devices (e.g., one or more systems, one or more devices) of environment 100 can perform one or more functions described as being performed by another set of systems or another set of devices of environment 100.

Referring now to FIG. 1B, FIG. 1B is a diagram of a non-limiting embodiment or aspect of an integrated sensor layout (e.g. sensor pad, one or more sensors, etc.) of sensor system 102 in which devices, systems, methods, and/or products described herein, may be implemented. As shown in FIG. 1B, systems and/or devices of the integrated sensor layout can interconnect with the sensors shown via wired connections, wireless connections, or a combination of wired and wireless connections.

In some non-limiting embodiments or aspects, an integrated sensor layout includes one or more sensors, a connector (e.g., a tail, an extension, a link, etc.), and a transmitter (e.g., a transmitter connects to the connector extending from the absorbent garment, etc.). In some non-limiting embodiments or aspects, the one or more sensors operate based on a connection between a connector (e.g., a sensor tail, an electronic interface, one or more conductive wires extending from a wetness sensor, etc.) and the transmitter to read (e.g., detect, etc.), generate, and transmit signals (e.g., sensor data, etc.). In some non-limiting embodiments or aspects, sensor system 102 (e.g., sensor and/or sensor pad) includes conductive ink lines to determine wetness, an interior sensor and an exterior sensor to determine a zone of wetness, and/or may be printed directly into a wearable absorbent garment (e.g., briefs, diapers, pull-ups, etc.) with a connector to facilitate the connection with a transmitter (e.g., the transmitter is attached). In one non-limiting embodiment or aspect, the connector attaches the transmitter to sensors 30b, 35b, 40b, via conductive pins that correspond with conductive ink lines. In another non-limiting embodiment or aspect, the sensors can be attached using an adhesive or some other material or compound to fasten the sensors.

In some non-limiting embodiments or aspects, the transmitter system is operative to receive and/or send a plurality of signals (e.g., electrical signals, etc.) through the sensors. For example, if wetness is detected between two points, a circuit will be formed at that location. In some non-limiting embodiments or aspects, the middle sensor 35b is energized with a ground signal, such that when moisture is present on the integrated sensor layout, a circuit is formed between two points and/or two integrated sensors (e.g. 30b, 40b, etc.) of the sensor system 102 and the transmitter operates to recognize characteristics of the electric signals in the circuits formed in the integrated sensor layout. For example, the transmitter determines or monitors the impedance of the completed circuits including the sensors to determine the change associated with an event occurring in the absorbent garment (e.g., a wetness event, detachment event, etc.).

As shown in FIG. 1B, in some non-limiting embodiments or aspects, the integrated sensor layout of sensor system 102 includes one or more sensors that are arranged in a predetermined fashion to ensure fast recognition of moisture on the sensor pad. For example, in some non-limiting embodiments or aspects, the sensors of the integrated sensor layout form an interior central detection zone and a perimeter zone. As an example, an interior sensor detects a central zone of wetness when urine (e.g. a liquid, etc.) forms a bridge across the interior sensor and a perimeter sensor detects a perimeter zone of wetness when urine forms a bridge across a perimeter sensor. In some non-limiting embodiments or aspects, when both a central zone and a perimeter zone are activated, a perimeter zone receives a heightened priority. In some non-limiting embodiments or aspects, the one or more sensors can be laid out alternatively on the integrated sensor layout (e.g., in a rectangular fashion, to handle a sensor pad or absorbent garment with other numbers of sensors, such as four or more, etc.).

In some non-limiting embodiments or aspects, the connector extends the sensors from the body of the absorbent garment to provide length and flexibility for reaching and/or connecting to the transmitter system. For example, the transmitter/connector interface may provide a soft point of failure for the transmitter system and pad combination to fail (e.g., a tear off, a partially attached connector, etc.) in the instance of a fall or tripping hazard situation. As an example, an integrated sensor layout includes a perforation along one edge so that it can be ripped off from the body of the pad. For example, this perforated edge with sensors 30b, 35b, and 40b defines the tail end of the integrated sensor layout and forms a path between the sensors of the transmitter system of the tail and the sensors of the body of the absorbent garment, designed to easily and quickly tear or pull from the absorbent garment to avoid accidents such as falling.

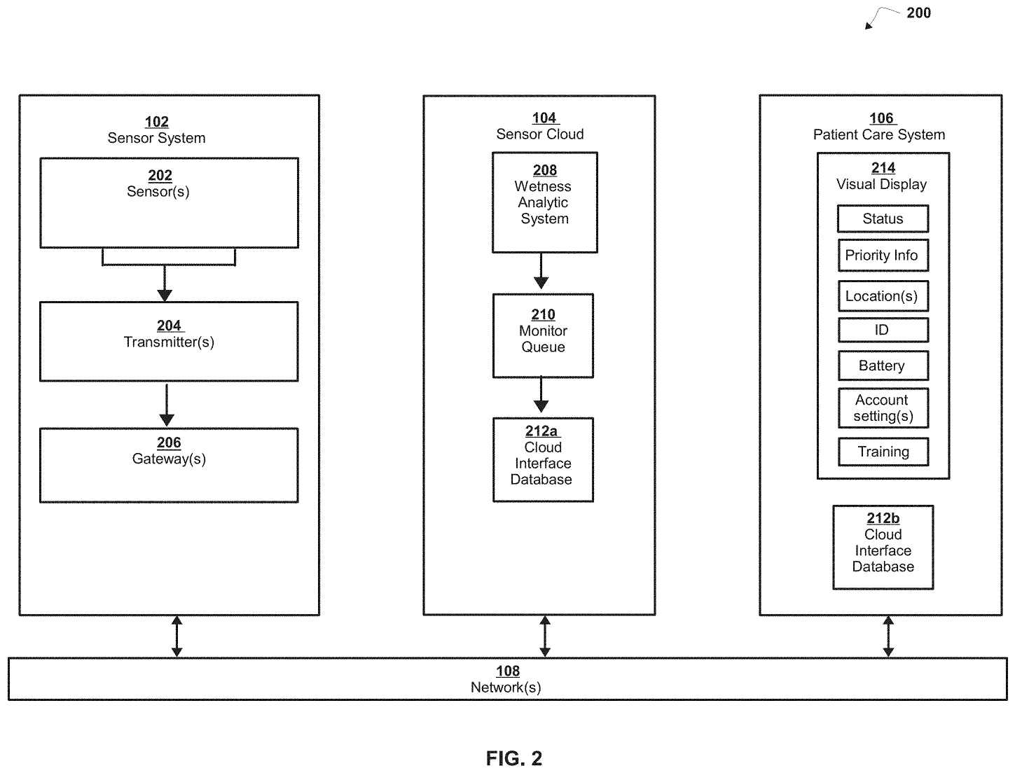

Referring now to FIG. 2, FIG. 2 is a diagram of a non-limiting embodiment or aspect of a cloud system 200 for limiting wetness exposure time in an absorbent garment. As shown in FIG. 2, cloud system 200 includes sensor system 102, sensor cloud 104, and patient care system 106 that cooperate to detect wetness in one or more sensors 202 of sensor system 102 in an absorbent garment, determine an action based on the absorbent garment information associated with the one or more sensors, limit wetness exposure time in the absorbent garment based on an absorbent garment information, and track patient data to store for future analytics.

In some non-limiting embodiments or aspects, sensor system 102 provides sensors 202, transmitter 204, and gateway 206. In some non-limiting embodiments or aspects, sensor system 102 includes one or more sensors 202 that operate based on a connection with a transmitter 204 to read (e.g., detect, etc.) and generate signals (e.g., sensor data, etc.). For example, in some non-limiting embodiments or aspects, sensor system 102 transmits sensor data generated from one or more sensors 202 (e.g., sensor pad, absorbent garment, etc.) coupled with transmitter 204 via gateway 206 in a form of signals and/or messages across a network 108 (e.g., including one or more of, in any combination, internet services, cloud service, hosted or standalone computers, iPads, smartphones, databases, or other transmitters, repeaters, or transceivers, etc.) to sensor cloud 104 which authenticates, validates, and forwards absorbent garment information to a patient care system 106, and/or the like. In some non-limiting embodiments or aspects, sensor system 102 provides sensor data to sensor cloud 104 for determining a priority level and patient identifier (e.g., a name and/or location of a patient, room number, etc.) when a new absorbent garment is needed (e.g., matching one or more new absorbent garments with a patient in the patient care system 106.).

In some non-limiting embodiments or aspects, transmitter 204 detects an event based on a connection and an open or closed circuit. For example, the transmitter 204 (e.g., one or more processors of transmitter 204, etc.) sends an electrical pulse to the one or more sensors 202 to determine if a closed circuit has formed. In some non-limiting embodiments or aspects, transmitter 204 detects a change in the connection or circuit (e.g., change in impedance, change in capacitance, etc.) to determine an event (e.g., a wet or dry condition, disconnection event, etc.) associated with an absorbent garment.

In some non-limiting embodiments or aspects, transmitter 204 generates a reading (e.g., sends an electrical pulse, activates sensors 202, etc.) which lasts for a predetermined period of time (e.g., reads for 2 seconds, 5 seconds, etc.) to verify a change in a connection or circuit (e.g., a wetness event, a disconnection event, etc.). In another configuration, transmitter 204 generates a reading in an interval of a predetermined period of time (e.g., reads every 2 seconds, 5 seconds, etc.) to verify a change in a connection or circuit (e.g., a wetness event, disconnection event, etc.). In some non-limiting embodiments or aspects, transmitter 204 sends a heartbeat (e.g., a signal to indicate that the transmitter is still on a network, connection status, etc.).

In some non-limiting embodiments or aspects, gateway 206 may receive, store, forward, authenticate, or modify sensor data. In some non-limiting embodiments or aspects, sensor system 102 provides gateway 206, for example, to modify and send sensor data to sensor cloud 104 via a processing device (e.g., messages sent wirelessly to a network, a computer, other transmitters, or any other device configured to receive and operate on the transmitted signals). In some non-limiting embodiments or aspects, transmissions (e.g., one or more signals, verified sensor data, a status, etc.) are modified with attributes including a transmitter identifier, timestamp, patient identifier (e.g., name and/or location of a patient, room number, etc.), and/or a condition based on the signal reading (e.g., confirmed event, online, wet or dry, attached or detached, etc.).

In some non-limiting embodiments or aspects, gateway 206 provides a store and forward method in which information is received and it is stored, modified, used, sent and/or the like, at a later time to the final destination (e.g., sensor cloud 104, patient care system, another gateway, another transmitter, etc.) or to another intermediate station. The gateway 206 verifies the integrity of the message before forwarding it. In general, this method is used for high mobility, for connecting one or more transmitters, for transmissions (etc., a direct, an end-to-end connection, etc.)

In some non-limiting embodiments or aspects, gateway 206 sends modified sensor data providing data to authenticate a message and validate a status of an absorbent garment (e.g., online, wet or dry, attached or detached, etc.). For example, gateway 206 collects sensor data from transmitter 204 to verify a consistency of readings in a transmitter over and/or for a predetermined period of time (e.g. 2 seconds, 5 seconds, etc.) and modifies it with attributes including a transmitter identifier, timestamp, patient identifier (e.g., location and/or name of a patient, room number, etc.), and/or a condition based on a signal reading (e.g., confirmed event, online, wet or dry, attached or detached, etc.).

With continued reference to FIG. 2, the number and arrangement of systems, devices, and networks shown in FIG. 2 are provided as an example. There can be additional systems, devices and/or networks, fewer systems, devices, and/or networks, different systems, devices, and/or networks, or differently arranged systems, devices, and/or networks than those shown in FIG. 2. Furthermore, two or more systems or devices shown in FIG. 2 can be implemented within a single system or a single device, or can be implemented as multiple, distributed systems or devices. Additionally, or alternatively, a set of systems or a set of devices (e.g., one or more systems, one or more devices) of cloud system 200 can perform one or more functions described as being performed by another set of systems or another set of devices of cloud system 200.

In some non-limiting embodiments or aspects, sensor cloud 104 receives sensor data from sensor system 102 and authenticates a message before validating the sensor data (e.g., a confirmed event, a status, etc.). For example, sensor cloud 104 provides analytic system 208 for authenticating one or more attributes of the sensor data by matching identifying information (e.g., identifying of one or more transmitters, one or more gateways, one or more sensors, or any combination, etc.) to stored data in the sensor cloud 104. In some non-limiting embodiments or aspects, analytic system 208 places the sensor data into monitor queue 210 to validate the status of the absorbent garment.

In some non-limiting embodiments or aspects, analytic system 208 validates sensor data (e.g., a confirmed event, status, etc.) based on a plurality of readings for the absorbent garment. In some non-limiting embodiments and aspects, analytic system 208 begins to track and/or monitor the data from transmitter 204 by placing a collection of readings into a monitor queue 210. For example, analytic system 208 places sensor data into monitor queue 210 for a measured period of time to monitor the consistency of the messages received. In some non-limiting embodiments or aspects, analytic system 208 validates a status of an absorbent garment based on the absence of a contradictory second reading being subsequently sensed within the measured period of time. For example, analytic system 208 validates the status of an absorbent garment based on the sensor data remaining consistent for the measured period of time (e.g. 3 minutes, 5 minutes, etc.) and cloud interface 212 transmits the validated sensor data (e.g., status, condition, confirmed event, etc.) in the form of absorbent garment information to patient care system 106.

In some non-limiting embodiments or aspects, analytic system 208 resets a status or a measured period of time. For example, analytic system 208 resets a status or a measured period of time based on receiving an inconsistent sensor data reading. In some non-limiting embodiments or aspects, analytic system 208 resets a status of an absorbent garment or measured period of time based on a contradictory second reading being subsequently sensed within a measured period of time.

In some non-limiting embodiments or aspects, analytic system 208 validates sensor data (e.g., a confirmed event, status, etc.) based on a plurality of readings for the absorbent garment. For example, analytic system 208 places sensor data into monitor queue 210 for a measured period of time to monitor the consistency of the messages received. The status of the absorbent garment as “not dry” indicates the absorbent garment may be wet, may have received a false positive or incorrect status, something other than urine is present (e.g., sweat, etc.), and/or the like.

In some non-limiting embodiments or aspects, monitor queue 210 determines a measured time period (e.g., a wetness time period, etc.) to track the transmitted data and validates its consistency before sending the absorbent garment information to patient care system 106. For example, monitor queue 210 delays transmitting absorbent garment information to patient care system 106 for a measured period of time (e.g., 3 minutes, 5 minutes, etc.) based on a plurality of readings to confirm a status of an absorbent garment.

In some non-limiting embodiments or aspects, analytic system 208 monitors data (e.g., collects sensor data received during the measured period of time, finds an updated status after an initial condition or event, etc.) to continuously update a status of an absorbent garment. In some non-limiting embodiments or aspects, for example, receiving no status update associated from the sensor data means it is attached and dry. In some non-limiting embodiments or aspects, analytic system 208 determines the absorbent garment is wet when receiving sensor data indicating a closed circuit has formed (e.g., change in impedance, change in a physical property, etc.).

In some non-limiting embodiments or aspects, analytic system 208 determines a priority level of a status of an absorbent garment. For example, in some non-limiting embodiments or aspects, analytic system 208 receives sensor data indicating a confirmed wetness event and determines a priority level of a status of the absorbent garment based on a time of the one or more confirmed wetness events (e.g., based on receiving messages from continuously updated sensor data and comparing it, etc.) and a zone of wetness (e.g., a central, perimeter, etc.). In some non-limiting embodiments or aspects, the priority level of a status associated with a wetness event may comprise a center wetness priority (e.g., closed circuit across the sensor located in the center of the garment, etc.) or a perimeter wetness priority (e.g., closed circuit across the sensor located on the perimeter of the garment, etc.).

In some non-limiting embodiments or aspects, analytic system 208 determines a priority level is higher when a wetness event occurs (e.g., center wetness has a higher priority than a dryness status, closed circuit has a higher priority level than open circuit, etc.), a higher priority level when a wetness event occurs in a perimeter zone (e.g. perimeter wetness has a higher priority level than center wetness, etc.), and/or a higher priority level when a longer amount of time has elapsed (e.g., 0-30 minutes, 30-60 minutes, etc.) from the initial validated wetness status.

With continued reference to FIG. 2, in some non-limiting embodiments or aspects, cloud interface 212 provides a sensor system database. For example, cloud interface 212 stores identifying data associated with sensor system 102 in a database (e.g., the sensor system database, a database having an identifier of a sensor, etc.) for associating a user (e.g., patient, resident, nurse, etc.) to a particular transmitter 204 to create a history profile. In some non-limiting embodiments or aspects, cloud interface 212 generates absorbent garment information by matching a validated status with identifying data stored in a database.

In some non-limiting embodiments or aspects, cloud interface 212 transmits absorbent garment information based on verified attributes of sensor data, a validated status of an absorbent garment, and identifying data stored in the sensor system database. For example, cloud interface 212 transmits absorbent garment information to patient care system 106 including identifying information associated with one or more patients or residents, a transmitter identifier, a status of an absorbent garment, and a priority level of the status of one or more absorbent garments.

In some non-limiting embodiments or aspects, patient care system 106 generates an action to limit wetness exposure time in an absorbent garment. For example, patient care system 106 provides visual display 214 (e.g., a mobile device, a mobile computer, a patient care device, a patient care monitor, etc.) to communicate absorbent garment information to a caretaker and generate an action to limit wetness exposure time. In some non-limiting embodiments or aspects, visual display 214 comprises information including a product type (e.g., absorbent garment, briefs, pull ups, diapers, etc.), a status of an absorbent garment, a priority level of a status based on time elapsed (e.g., time since wetness detected, etc.) and a zone of wetness, user settings, training materials, technical support, and battery voltage.

In some non-limiting embodiments or aspects, visual display 214 indicates or provides a validated status (e.g., a confirmed event, a state of an absorbent garment based on absorbent garment information, a priority level of a status, etc.) via one or more messages. For example, visual display 214 uses one or more messages to communicate connectivity of the transmitter (e.g., “Transmitter Connected” message, “Transmitter Disconnected” message, etc.), a status of the absorbent garment (e.g., “Garment Wet” message, “Garment Dry” message, etc.), and a priority level of the status (e.g., high priority based on time elapsed and zone of wetness, etc.).

In some non-limiting embodiments or aspects, visual display 214 indicates a priority level of a status for an absorbent garment. For example, in some non-limiting embodiments and aspects, visual display 214 is configured to show blue (0-30 minutes wetness exposure), configured to show orange (30-60 minutes wetness exposure), and/or configured to provide one or more alerts to limit wetness exposure time in an absorbent garment.

In some non-limiting embodiments or aspects, patient care system 106 includes one or more databases (e.g., cloud interface database 212) to store, receive, or provide analysis of patient information, event history, and operational data of transmitter 204 (e.g., performance metrics of transmitter 204, etc.). For example, in some non-limiting embodiments or aspects, cloud interface database 212 compares or selects information reports of an absorbent garment, information for one or more absorbent garments associated with a patient, information for one or more absorbent garments associated with another patient, information for a group of patients to classify events, segment events, create or obtain a patient profile, and/or the like. In some non-limiting embodiments or aspects, a classification model may compare information from a plurality of prior reports associated with absorbent garment information.

In some non-limiting embodiments or aspects, patient care system 106 includes cloud interface 212 to store, monitor, and/or compare absorbent garment information to determine a priority queue for handling events (e.g., assigning an order or queue, triaging emergent situations, continually updated priority status, etc.) based on a length of time or extent (e.g., a state) of the event, and/or track the information associated with the amount of time an absorbent garment remains unchanged (e.g., response time, performance optimization, etc.).

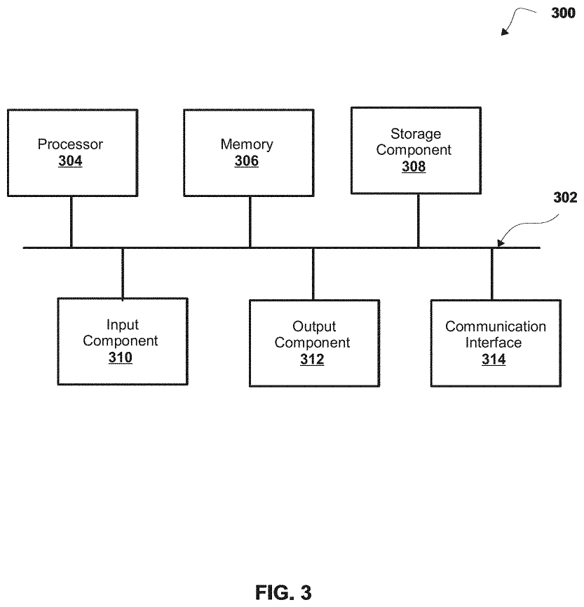

Referring now to FIG. 3, FIG. 3 is a diagram of example components of a device 300 of the present disclosure. Device 300 may correspond to one or more devices of a cloud-implemented method and wetness detection system, one or more devices of the present disclosure that may include at least one device 300, and/or at least one component of device 300. Referring to FIG. 3, the device 300 may include bus 302, processor 304, memory 306, storage component 308, input component 310, output component 312, and communication interface 314. In one embodiment, these elements of a device 300 and the other elements of a device 300 described herein correspond to the cloud-implemented method and wetness detection system, as described herein.

Bus 302 may include a component that permits communication among the components of device 300. In some non-limiting embodiments or aspects, processor 304 is implemented in hardware, firmware, or a combination of hardware and software. For example, processor 304 includes a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 may include a random access memory (RAM), a read only memory (ROM), and/or another type of dynamic or static storage device (e.g., flash memory, magnetic memory, optical memory, etc.) that stores information and/or instructions for use by processor 304.

Storage component 308 may store information and/or software related to the operation and use of device 300. For example, storage component 308 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 310 may include a component that permits device 300 to receive information, such as via user input (e.g., a touch screen display, a keyboard, a keypad, a mouse, a button, a switch, a microphone, etc.). Additionally, or alternatively, input component 310 may include a sensor for sensing information. Output component 312 may include a component that provides output information from device 300 (e.g., a display, a speaker, one or more light-emitting diodes (LEDs), an alarm, etc.).

Communication interface 314 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 314 may permit device 300 to receive information from another device and/or provide information to another device. For example, communication interface 314 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 304 executing software instructions stored by a computer-readable medium, such as memory 306 and/or storage component 308. A computer-readable medium (e.g., a non-transitory computer-readable medium) is defined herein as a non-transitory memory device. A memory device may include memory space located inside of a single physical storage device or memory space spread across multiple physical storage devices.

Software instructions may be read into memory 306 and/or storage component 308 from another computer-readable medium or from another device via communication interface 314. When executed, software instructions stored in memory 306 and/or storage component 308 may cause processor 304 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 3 are provided as an example. In some non-limiting embodiments or aspects, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

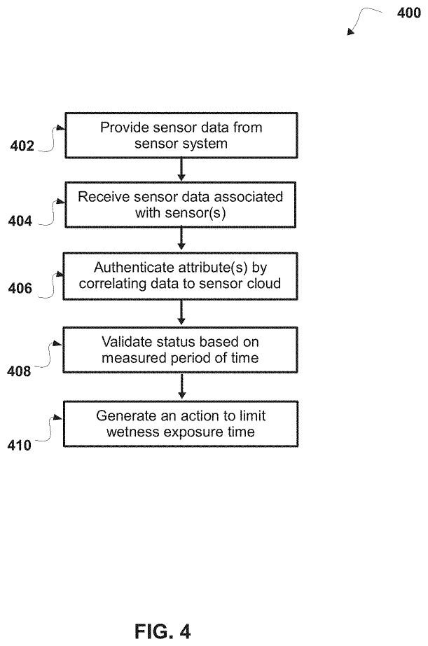

Referring now to FIG. 4, FIG. 4 is a flowchart of a non-limiting embodiment or aspect of a process 400 for a cloud-implemented method and wetness detection system. In some non-limiting embodiments or aspects, one or more of the steps of process 400 are performed (e.g., completely, partially, etc.) by sensor system 102 (e.g., one or more devices of sensor system 102, etc.). In some non-limiting embodiments or aspects, one or more of the steps of process 400 are performed (e.g., completely, partially, etc.) by another device or a group of devices separate from or including sensor system 102, such as one or more devices (e.g., one or more devices of a system of) of sensor cloud 104 and patient care system 106.

As shown in FIG. 4, at step 402, process 400 includes providing sensor data associated with one or more absorbent garments including one or more sensors. For example, sensor system 102 provides, generates, obtains, receives, or detects sensor data associated with one or more absorbent garments including one or more sensors 202, wherein the sensor data includes one or more events determined by a change in the connection or circuit of the sensor system 102 to provide a status of the absorbent garment that can be used to determine a condition of the absorbent garment. For example, the sensor data provides information to the sensor cloud 104 that can be used to make determination about resource allocation or logistical allocation including one or more events associated with a status of an absorbent garment, a priority level of the status, a priority level further communicating a precedent of one or more events based on both the time and extent of the event, and/or the like.

In some non-limiting embodiments or aspects, for example, transmitter 204 detects an event in one or more sensors of the one or more absorbent garments. In some non-limiting embodiments or aspects, sensor system 102 verifies the one or more events by establishing a precedent (e.g., a plurality of readings (e.g., a sequence) collected over a time period, a particular message received for a predetermined period of time, a particular order of a message or sequence of messages, a transmitter address, a gateway address, number of network hops, etc.,) for one or more events associated with one or more absorbent garments based on the consistency (e.g., an order, an average, a mode, etc.) of the sensor data readings. For example, transmitter 204 detects a wetness event at sensor 202 (e.g., the sensor 202 becomes a closed circuit, one or more sensors are bridged to change resistance, one or more sensors change with respect to a physical property, electrical property, a chemical property, etc.) and gateway 206 stores, tracks, and/or transmits the sensor data to sensor cloud 104. In some non-limiting embodiments or aspects, gateway 206, transmitter 204 transmits sensor data which includes a status (e.g., a condition assigned before transmission, a confirmed event, a state of a sensor, etc.) and one or more attributes including operational data, a transmitter identifier, timestamp, and/or a patient identifier (e.g., a location of a patient, a name of a patient, a room number, a number, letter, characters, and/or the like for at least partially identifying an absorbent garment or sensor, etc.). In some non-limiting embodiments or aspects, the operational data may include an attachment or detachment reading, an indication that a transmitter 204 is online, and/or a battery voltage reading.

In some non-limiting embodiments or aspects, transmitter 204 generates a reading (e.g., sends an electrical pulse, activates sensors 202, etc.) which is stored and monitored for a predetermined period of time (e.g., a period established to confirm a reading, for 2 seconds, for 5 seconds, a variable period based on obtained sensor data, etc.) to verify a change in the connection or circuit (e.g., a wetness event, disconnection event, etc.). In another configuration, transmitter 204 generates a reading in an interval of a predetermined period of time (e.g., reads every 2 seconds, 5 seconds, etc.) to verify a change in the connection or circuit (e.g., operational data, patient identifier, status of the absorbent garment, priority level, etc.) at a predetermined time (e.g., transmits every 5 seconds and/or reads for 3 seconds at a time, etc.).

In some non-limiting embodiments or aspects, gateway 206 transmits the data to a computer system comprising one or more processors (e.g., a cloud computer, a central computer system, a central sensor system, etc.). In some non-limiting embodiments or aspects, sensor system 102 provides gateway 206 configured to delay transmitting the data for a predetermined period of time (e.g., 3 seconds, 5 seconds, etc.). For example, gateway 206 verifies the sensor data of a first reading based on the absence of a contradictory second reading being subsequently sensed within the predetermined period of time.

In some non-limiting embodiments or aspects, a circuit is closed when wetness bridges (e.g., connects two points of an open sensor to form a closed circuit, etc.) or allows formation of a circuit between the sensors 202 of sensor system 102, placing the transmitter 204 in communication with the sensors 202 that determine moisture data associated with an absorbent garment. In this manner, the transmitter 204 receives an electrical signal including a measurable characteristic of the sensor 202. In some non-limiting embodiments or aspects, transmitter 204 determines an impedance of a sensor 202. For example, in some non-limiting embodiments or aspects, sensor system 102 determines an impedance (e.g., capacitance, etc.) in a circuit formed of urine on the absorbent garment.

In some non-limiting embodiments or aspects, process 400 includes transmitting the sensor data, including one or more events associated with an absorbent garment (e.g., wet or dry condition, attachment or detachment of the transmitter, etc.) to sensor cloud 104 in the absence of a contradictory reading being subsequently sensed within the predetermined period of time and/or not transmitting (e.g., delaying, canceling, resetting, etc.) the sensor data associated with an absorbent garment (e.g., wet or dry condition, attachment or detachment of the transmitter, etc.), to sensor cloud 104 when a contradictory reading is subsequently sensed within the predetermined period of time (e.g., 2 seconds, 5 seconds, etc.).

As shown in FIG. 4, at step 404, process 400 includes receiving sensor data associated with one or more sensors 202 in an absorbent garment. For example, in some non-limiting embodiments or aspects, sensor cloud 104 receives sensor data including one or more events based on a connection and/or an open or closed circuit across one or more sensors 202 of sensor system 102. For example, sensor cloud 104 receives data associated with a wetness, a moisture, urine, and/or some other chemical substance interacting with a sensor, a detachment of a sensor from the system, an attachment of a sensor to the system, and/or the like. In some non-limiting embodiments or aspects, sensor cloud 104 receives sensor data from sensor system 102 modified with one or more attributes including a transmitter identifier, a timestamp, an event associated with a wet or dry condition, an event associated with an attachment or detachment, a zone of wetness, a location identifier, and/or a patient identifier.

In some non-limiting embodiments or aspects, sensor cloud 104 receives sensor data associated with the status of an absorbent garment. For example, sensor data received from sensor system 102 includes a status comprising one or more confirmed events (e.g., a wet or dry condition, connection or disconnection event, etc.) and identifying attributes (e.g., operational data, transmitter identifier, patient identifier, etc.) associated with an absorbent garment. In some non-limiting embodiments or aspects, the status of an absorbent garment is based on one or more confirmed events associated with a wet or dry condition, a connection or disconnection event, and/or a zone of wetness. In some non-limiting embodiments or aspects, sensor cloud 104 verifies and stores at least one event of the one or more events from the portion of the data associated with a status of one or more absorbent garments.

In some non-limiting embodiments or aspects, sensor cloud 104 receives sensor data associated with a priority level of a status. For example, the status of an absorbent garment further comprises a priority level which is based on the time elapsed and a zone of wetness related to a confirmed event. In some non-limiting embodiments or aspects, a wet condition has a higher priority level than a dry condition (e.g., center wetness has a higher priority than a dryness status, closed circuit has a higher priority level than open circuit, etc.), and a wetness event occurring in a perimeter zone has a higher priority level than a wetness event occurring in a central zone (e.g. perimeter wetness has a higher priority level than center wetness, etc.)

In some non-limiting embodiments or aspects, sensor cloud 104 stores and monitors sensor data associated with the status of an absorbent garment. For example, sensor cloud 104 collects sensor data readings received from sensor system 102 to monitor a consistency of the messages associated with one or more confirmed events (e.g., a wet or dry condition, connection or disconnection event, etc.) and identifying attributes (e.g., operational data, transmitter identifier, patient identifier, etc.) associated with an absorbent garment. In some non-limiting embodiments or aspects, sensor cloud 104 authenticates, verifies, and stores at least one event of the one or more events from the portion of the data associated with a status of one or more absorbent garments to generate an action to limit wetness exposure time and/or create a history profile.

As shown in FIG. 4, at step 406, process 400 includes authenticating one or more attributes of the sensor data received from sensor system 102. For example, sensor system 104 authenticates the one or more attributes of the sensor data by correlating at least one attribute with data in sensor cloud 104. In some non-limiting embodiments or aspects, sensor cloud 104 obtains data (e.g., a database, a file, a message, etc.), the data can contain or store data associated with one or more transmitters, and data input by a user may be stored to at least partially identify a sensor system 102, a patient, a physical location, and/or the like. For example, in some non-limiting embodiments or aspects, sensor cloud 104 authenticates one or more attributes associated with the sensor data including a transmitter identifier, a timestamp, an event associated with a wet or dry condition, an event associated with an attachment or detachment, a zone of wetness, a location identifier, and/or a patient identifier.

In some non-limiting embodiments or aspects, sensor cloud 104 stores account information input by a user (e.g., stores identifying information for correlating an account, etc.). For example, in some non-limiting embodiments or aspects, sensor cloud 104 identifies an account by associating an account to at least one transmitter assigned to at least one patient of the at least one care facility. In some non-limiting embodiments or aspects, sensor cloud 104 creates a history profile including event data, operational data, identifying information, data associated with care needs, and a record of care given. In some non-limiting embodiments or aspects, sensor cloud 104 provides information based on a history profile. For example, a history profile can be used to validate or authenticate messages.

As shown in FIG. 4, at step 408, process 400 includes validating the status of an absorbent garment based on a measured period of time. For example, in some non-limiting embodiments or aspects, sensor cloud 104 validates the status of an absorbent garment (e.g., wet or dry condition, connected or disconnected, etc.) based on receiving consistent data readings for a measured period of time. For example, sensor cloud 104 monitors the sensor data for consistency over a measured period of time (e.g., 3 minutes, 5 minutes, etc.) to generate absorbent garment information including authenticated sensor data, a validated status, and identifying information.

In some non-limiting embodiments or aspects, sensor cloud 104 receives an inconsistent sensor data reading within a measured period of time. For example, sensor cloud 104 monitors the sensor data readings for a measured period of time (e.g., 3 minutes, 5 minutes, etc.) and, in response to receiving an inconsistent reading, resets the measured period of time without transmitting the absorbent garment information. As an example, sensor cloud 104 receives a dry event after a wet event, a connect event after a disconnect event, and/or the like. In some non-limiting embodiments or aspects, sensor cloud 104 is configured to delay transmitting absorbent garment information upon receiving a contradictory reading (e.g., reset a transmission, change a transmission, cancel a message, etc.). For example, sensor cloud 104 resets a status and the measured period of time for validation in response to receiving an inconsistent sensor data reading (e.g., received a false positive or incorrect status, something other than urine is present (e.g., sweat, etc.), and/or the like).

In some non-limiting embodiments or aspects, sensor cloud 104 generates absorbent garment information based on a status and the authenticated sensor data of an absorbent garment remaining consistent for a measured period of time. In some non-limiting embodiments or aspects, the absorbent garment information generates or provides at least one of a validated status (e.g., at least one confirmed event, a condition associated with the absorbent garment, etc.), a product type, a priority level of the status (e.g., time elapsed for an event, zone of wetness, etc.), a transmitter identifier, a timestamp, one or more previous events associated with the transmitter, and/or a patient identifier.

In some non-limiting embodiments or aspects, sensor cloud 104 validates and stores sensor data associated with one or more statuses of one or more absorbent garments. As an example, sensor cloud validates the sensor data and stores the sensor data by associating the validated statuses of one or more absorbent garments to a user account to generate absorbent garment information related to one or more patients or residents of a patient care system 106.

In some non-limiting embodiments and aspects, sensor cloud 104 transmits absorbent garment information to patient care system 106 to generate an action to limit wetness exposure time in an absorbent garment. For example, sensor cloud 104 sends absorbent garment information to patient care system 106 after validating statuses of one or more absorbent garments associated with the patient care facility.

In some non-limiting embodiments or aspects, sensor cloud 104 sends absorbent garment information related to one or more patients in patient care system 106. For example, sensor cloud 104 tracks the time of a validated status for comparing data to previous data received before sending to provide updated information. In one non-limiting embodiments or aspects, sensor cloud 104 tracks the validated sensor data of a single patient (e.g., a particular transmitter or sensor, etc) to create a history profile that can be used to at least partially determine or predict a patient priority or need. In another configuration, sensor cloud 104 tracks the validated sensor data of multiple patients to compare sensor data and establish a priority level related to patient care needs.

In some non-limiting embodiments or aspects, sensor cloud 104 transmits absorbent garment information to patient care system 106. For example, sensor cloud 104 transmits absorbent garment information based on a validated status to generate an action for limiting wetness exposure time in an absorbent garment. In some non-limiting embodiments or aspects, sensor cloud 104 sends absorbent garment information to a visual display of patient care system 106 to provide continual monitoring of one or more patient's care needs.

As shown in FIG. 4, at step 410, process 400 includes generating an action to limit wetness exposure time in the absorbent garment based on the absorbent garment information. For example, in some non-limiting embodiments or aspects, patient care system 106 limits wetness exposure time in the absorbent garment by presenting a continuously updated status of the absorbent garment and tracking the time of a confirmed event (e.g., wetness event, zone of wetness, disconnection event, etc.) to provide prioritization of care needs. In some non-limiting embodiments or aspects, patient care system 106 limits wetness exposure time in the absorbent garment by determining an action for the absorbent garment based on the priority level of the status of absorbent garment.

In some non-limiting embodiments or aspects, patient care system 106 communicates a priority level of a status of an absorbent garment to generate an action to limit wetness exposure time. In some non-limiting embodiments or aspects, patient care system 106 is configured to show a status (e.g., confirmed event, wet or dry condition or event, connection or disconnection event, etc.), type of product (e.g., briefs, sensor pad, diapers, etc.), and a priority level based on the time elapsed and/or a zone of wetness (e.g., configured to show blue or orange, center or perimeter wetness, a time of one or more events, a predicted time, etc.). In some non-limiting embodiments or aspects, patient care system 106 provides a patient care staff with a priority level that can be used to limit a patient's exposure to wetness in the absorbent garment. For example, a priority level can be further implemented in a patient care schedule to limit a patient's exposure to wetness.

In some non-limiting embodiments or aspects, patient care system 106 generates an action to limit wetness exposure time based on absorbent garment information. For example, patient care system 106 stores, monitors, and/or compares absorbent garment information to determine a priority queue for handling events (e.g., assigning an order or queue, triaging emergent situations, continually updated priority status, etc.) based on the length of time or extent of the event, and/or tracks the information associated with the amount of time an absorbent garment remains unchanged (e.g., response time, performance optimization, etc.).

In some non-limiting embodiments or aspects, patient care system 106 prepares an alert (e.g., a warning, a chime, an alarm, etc.) based on priority level of a status. For example, patient care system 106 generates an action (e.g., an alert, a visual indicator, etc.) to limit wetness exposure time in an absorbent garment based on the priority level of a status associated with one or more residents and/or patients providing patient care facility staff and/or a caregiver the ability to prioritize the most acute needs. In some non-limiting embodiments or aspects, patient care system 106 provides a patient care staff with an action that limits a patient's exposure to wetness in the absorbent garment.

In some non-limiting embodiments or aspects, patient care system 106 compares absorbent garment information to track the care needs of one or more patients. For example, patient care system 106 compares current absorbent garment information to data from a prior report of an absorbent garment, information for one or more absorbent garments associated with a patient to each other, information for one or more absorbent garments associated with different patients, and/or information for a group of patients to classify events and create a patient profile.

In some non-limiting embodiments or aspects, process 400 includes resetting a status of an absorbent garment from a wetness status to a dryness status (e.g., cancels a measured period of time, resets absorbent garment information, etc.) when the absorbent garment is replaced. For example, when a transmitter 204 is disconnected and reconnected to a new absorbent garment, patient care system 106 resets the garment status display. In some non-limiting embodiments or aspects, patient care system 106 monitors and stores data associated to the frequency of patient's absorbent garment needs to optimize the response time of a caregiver or patient care staff.

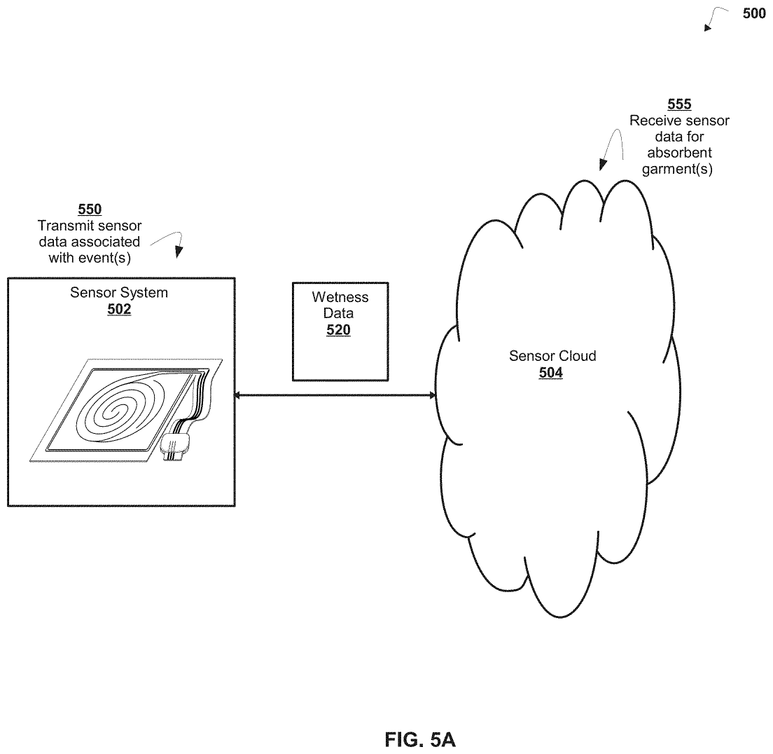

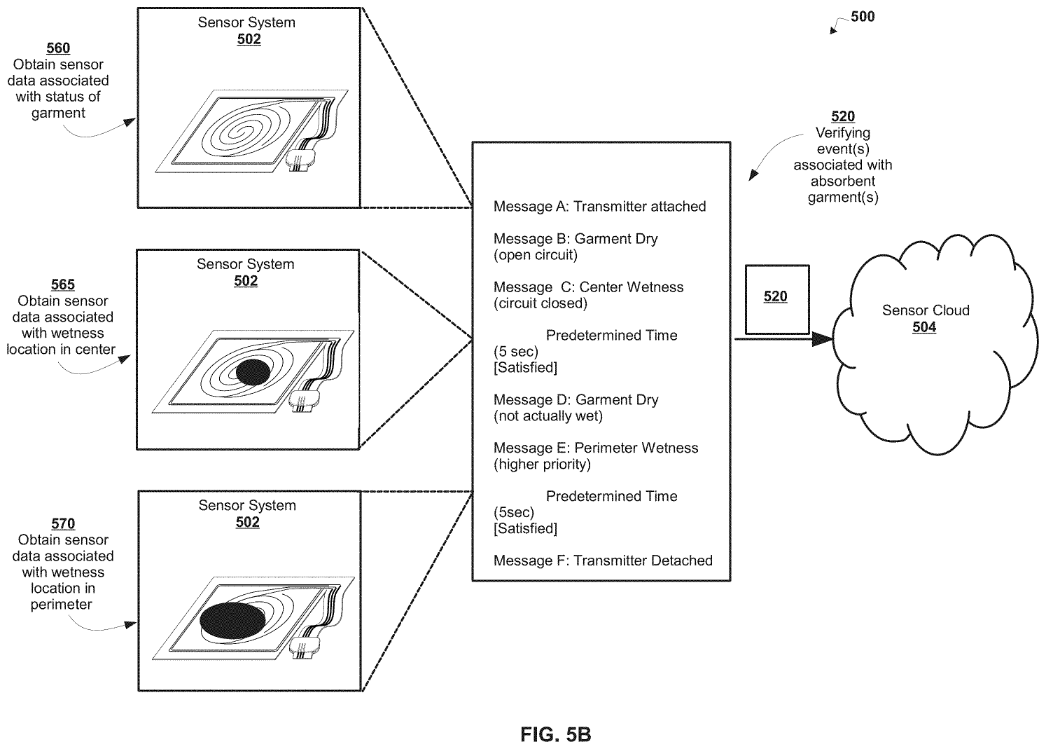

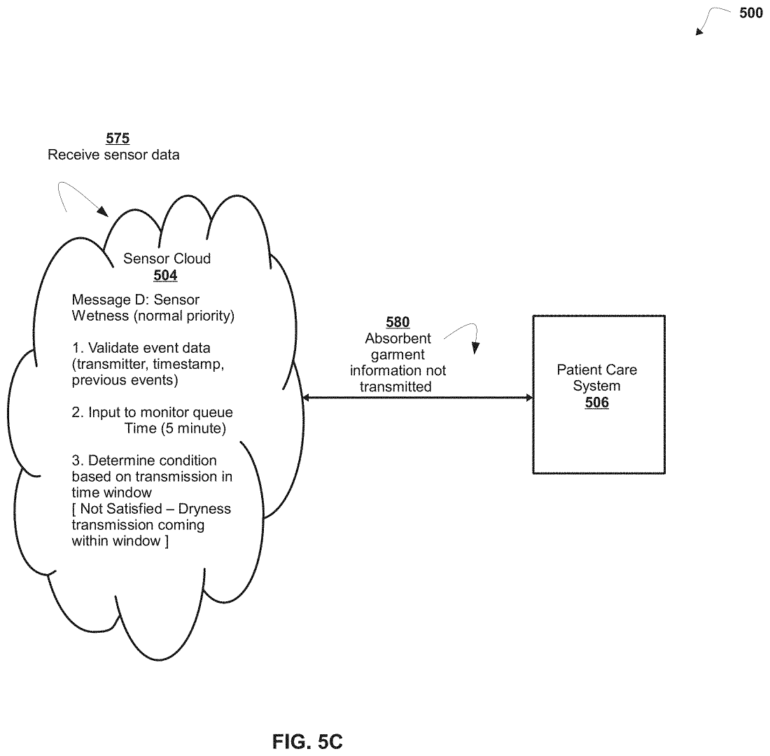

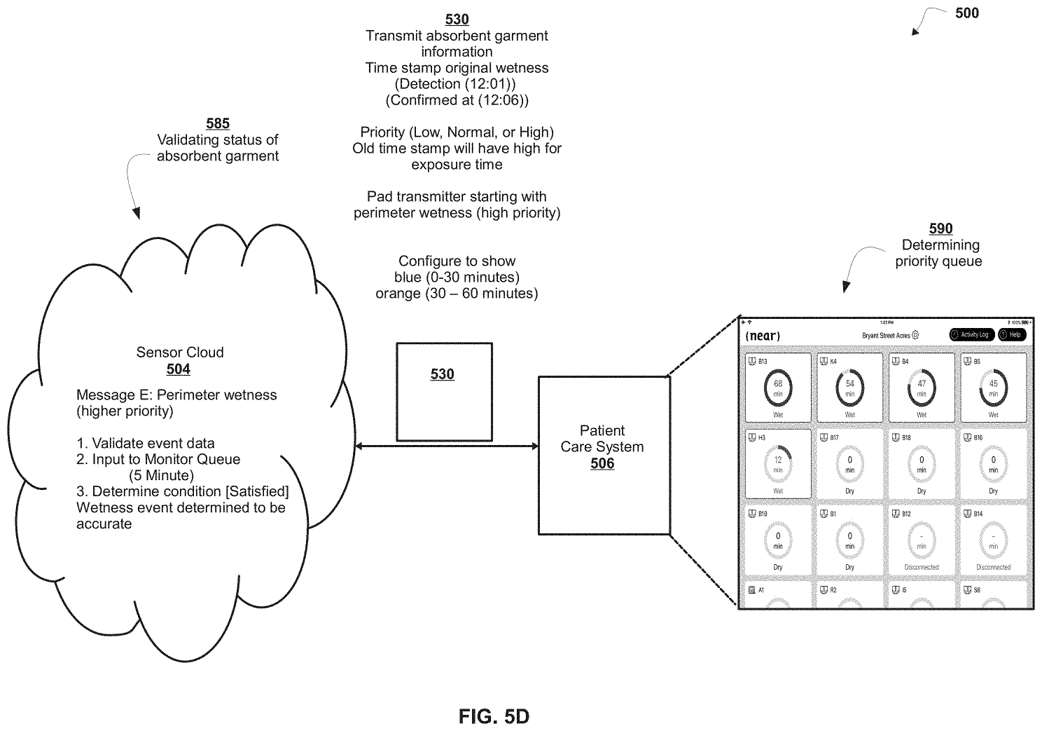

Referring now to FIGS. 5A-5D, FIGS. 5A-5D are diagrams of an overview of a non-limiting embodiment or aspect of an implementation 500 relating to one or more processes disclosed herein. As shown in FIGS. 5A-5D, implementation 500 includes sensor system 502, sensor cloud 504, sensor data 520, and absorbent garment information 530. In some non-limiting embodiments or aspects, sensor system 502 can be the same or similar to sensor system 102.

As shown by reference number 550 in FIG. 5A, implementation 500 includes transmitting sensor data associated with a sensor system 502 of an absorbent garment. For example, in some non-limiting embodiments or aspects, sensor system 502 detects an event in the absorbent garment (e.g., wet or dry condition, connection or disconnection event, etc.) based on transmitter 204 generating readings at a predetermined time, for a predetermined time interval (e.g., periodically, such as every 2 seconds, 5 seconds, etc.), and/or the like, and analytic system 208 authenticates the message by determining one or more attributes of the sensor data is trusted (e.g., matching, correlating, and/or confirming one or more attributes to data stored in the sensor cloud, etc.). In some non-limiting embodiments or aspects, monitor queue 210 logs and tracks data for a validation period (e.g., 3 minutes, 5 minutes, etc.) to confirm the status is trusted (e.g., monitors sensor data for consistency, does not receive an inconsistent reading, etc.).

As shown by reference number 555 in FIG. 5A, implementation 500 includes receiving sensor data associated with one or more absorbent garments. For example, in some non-limiting embodiments or aspects, transmitter 204 sends a heartbeat (e.g., a signal to indicate that the transmitter 204 is still on the network, etc.) to confirm it is active. In some non-limiting embodiments or aspects, transmitter 204 sends (e.g., transmits, etc.) sensor data associated with the absorbent garment, including data for determining the one or more absorbent garments are wet, dry, attached, detached, have a priority level (e.g., event data indicating a wetness, dryness, attachment, detachment, location of a wetness event, etc.) based on a condition assigned before transmission, identifier information about the location of a sensor system 102, an identifier or name of a patient associated with a particular sensor system 102, operational data (e.g., transmitter is online, etc.), and/or the like. In some non-limiting embodiments or aspects, transmitter 204 provides a gateway 206 to store, modify, authenticate, or forward sensor data associated with the absorbent garment with attributes including a timestamp, status, priority level (e.g., zone of wetness, etc.), or identifying information (e.g., transmitter identifier, name and/or location of a patient, room number, etc.).

As shown by reference number 560 in FIG. 5B, implementation 500 includes obtaining sensor data associated with the status (e.g., wet or dry condition, connection or disconnection, etc.) of an absorbent garment. For example, the sensor data includes an attachment or detachment of an absorbent garment (e.g., transmitter 204 is attached to a sensor in an absorbent garment, transmitter 204 is unattached from a sensor in an absorbent pad, etc.), wetness or dryness event, and/or priority level associated with the status of the absorbent garment. In some non-limiting embodiments or aspects, transmitter 204 of sensor system 502 is configured to generate a reading (e.g., sends an electrical pulse, activates sensors 202, etc.) which lasts for a predetermined period of time or is generated at a predetermined period of time (e.g., reads for 2 seconds or 5 seconds, takes a reading every 2 seconds or 5 seconds, etc.) to verify a change in a connection or circuit (e.g., a wetness event, disconnection event, etc.). In some non-limiting embodiments or aspects, transmitter 204 is configured to delay transmitting data for a predetermined period of time based on readings of the transmitter 204 remaining consistent and an absence of a contradictory second reading being subsequently sensed within the predetermined period of time.

As shown by reference number 565 in FIG. 5B, implementation 500 includes obtaining sensor data associated with a center wetness priority level based on the location of the one or more sensors 202 of sensor system 502. For example, in some non-limiting embodiments or aspects, sensor system 502 provides one or more sensors 202 to detect a wetness in a position of an absorbent garment. For example, a central or an interior zone (e.g., a central area, a central detection zone, etc.). In some non-limiting embodiments or aspects, a center wetness status is provided a higher priority than a dryness status. In some non-limiting embodiments or aspects, a priority level of the center wetness status includes the time elapsed from the event occurring (e.g., a timestamp, shows blue (0-30 minutes), shows orange (30-60 minutes, etc.).

As shown by reference number 570 in FIG. 5B, implementation 500 includes obtaining sensor data associated with a perimeter wetness priority level based on the location of the one or more sensors 202 of sensor system 502. For example, in some non-limiting embodiments or aspects, sensor system 502 provides one or more sensors 202 to detect a wetness in a perimeter or an exterior zone (e.g., a perimeter area, a boundary area, an edge of an absorbent garment, an area outside a center, etc.). In some non-limiting embodiments or aspects, sensor system 502 provides additional positions, such as a perimeter wetness status that can provide status used to determine a priority. In some non-limiting embodiments or aspects, a perimeter wetness status has a higher priority than a center wetness status (e.g., has a greater extent of wetness, larger amount of wetness, etc.). In some non-limiting embodiments or aspects, a priority level of a perimeter wetness status includes a time elapsed since an event occurring. As an example, patient care system may visually display information associated with an absorbent garment for determining a priority level, (e.g., a timestamp, an indicator that shows blue (indicating 0-30 minutes elapsed), an indicator that shows orange (indicating 30-60 minutes elapsed), etc.). In some non-limiting embodiments or aspects, a priority level is used to indicate an ordering for when an absorbent garments should be changed with respect to one or more another absorbent garments.

As shown in FIG. 5B, implementation 500 includes verifying sensor data associated with one or more events related to the transmitter 204 to provide input 520 to a gateway or directly to a sensor cloud 504 for generating absorbent garment information. For example, the sensor data (e.g., one or more events, messages A-F, a wet, dry, or connection condition, etc.) is collected and monitored by gateway 206 to verify the consistency of the messages received. In such an example, gateway 206 compares one or more previous sensor data messages (e.g., sensor data previously received that may comprise one or more events associated with the one or more absorbent garments), to continuously updated sensor data which is generated in a predetermined period or for a predetermined period of time to monitor for consistency.

As shown by reference number 575 in FIG. 5C, implementation 500 includes receiving sensor data from sensor system 502 including one or more messages (e.g., one or more events, messages A-F, a wet, dry, or connection condition, etc.) associated with the status of an absorbent garment. For example, in some non-limiting embodiments or aspects, sensor cloud 504 receives sensor data indicating a dryness status (e.g., a condition assigned before transmission, open circuit, no updated events, etc.), wetness status (e.g., closed circuit, center or perimeter wetness, etc.), and/or a connection status (e.g., transmitter connected, transmitter disconnected, etc.). In some non-limiting embodiments or aspects, sensor cloud 504 validates sensor data (e.g., a confirmed event, status, etc.) based on a plurality of readings for the absorbent garment remaining consistent for a measured period of time. For example, sensor cloud 504 is configured to delay transmitting absorbent garment information based on receiving an inconsistent reading.

As shown by reference number 580 in FIG. 5C, implementation 500 includes not transmitting absorbent garment information. In some non-limiting embodiments or aspects, sensor cloud 504 is configured to delay transmitting absorbent garment information based on receiving inconsistent sensor data. For example, if sensor cloud 504 receives sensor data that is not consistent for a measured period of time, the status and measured period of time are reset and a new collection of readings is monitored.

As shown by reference number 585 in FIG. 5D, implementation 500 includes validating a status of an absorbent garment. For example, in some non-limiting embodiments or aspects, sensor system 502 sends data to sensor cloud 504 indicating a status of an absorbent garment. In some non-limiting embodiments or aspects, sensor cloud 504 determines a validation of a status in the absorbent garment by tracking the consistency of the readings for a measured period of time (e.g., 3 minutes, 5 minutes, etc.). In some non-limiting embodiments or aspects, sensor data received in a measured period of time may not override sensor data with a higher priority level in the same measured period of time. For example, a wetness status (e.g., a wetness event, center wetness, etc.) has a higher priority level than a dryness status and a perimeter wetness status has a higher priority level than a center wetness status (e.g., has a greater extent of wetness, larger amount of wetness, etc.).

As shown by reference number 530 in FIG. 5B, implementation 500 includes transmitting absorbent garment information. In some non-limiting embodiments or aspects, sensor cloud 504 is configured to transmit absorbent garment information based on validating the status of an absorbent garment. For example, sensor cloud 504 validates a status (e.g., a confirmed event, sensor data associated with a condition of an absorbent garment, etc.) based on a plurality of readings for the absorbent garment remaining consistent for a measured period of time. In some non-limiting embodiments or aspects, absorbent garment information includes at least one of a validated status (e.g., at least one confirmed event, a condition associated with the absorbent garment, etc.), a product type, a priority level of the status (e.g., time elapsed for an event, zone of wetness, etc.), a transmitter identifier, a timestamp, one or more previous events associated with the transmitter, and/or a patient identifier.

As shown by reference number 590 in FIG. 5D, implementation 500 includes determining a priority queue for handling events (e.g., a message handler assigning an order or queue, prioritizing or triaging an urgent status or conditions, continually or periodically updating a priority status, etc.) based on a length of time or extent related to other characteristics of the event, and/or tracking the information associated with the amount of time an absorbent garment remains unchanged (e.g., response time, performance optimization, etc.). In some non-limiting embodiments or aspects, an older time stamp will show a higher exposure time (e.g., higher priority, etc.) as a judging factor for prioritizing a patient care route or schedule. For example, in some non-limiting embodiments and aspects, patient care system 506 is configured to show blue (0-30 minutes wetness exposure), configured to show orange (30-60 minutes wetness exposure), or the like, and/or configured to provide one or more alerts to limit wetness exposure time in an absorbent garment. In some non-limiting embodiments or aspects, a wetness status (e.g., a wetness event, center wetness, etc.) has a higher priority level than a dryness status and a perimeter wetness status has a higher priority level than a center wetness status (e.g., has a greater extent of wetness, larger amount of wetness, etc.).

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A cloud-implemented method of limiting wetness exposure time in an absorbent garment, the method comprising:
providing sensor data from a sensor system including one or more absorbent garments, one or more sensors, and one or more processors;
receiving, by a sensor cloud including one or more processors, sensor data associated with the one or more sensors, wherein the sensor data includes one or more events determined by a connection and an open or closed circuit in a sensor of the one or more sensors to provide a status of the absorbent garment, and wherein the sensor data includes one or more attributes;
authenticating, by the sensor cloud, in response to receiving the sensor data, at least one attribute of the one or more attributes by correlating the at least one attribute to data in the sensor cloud;
validating, by the sensor cloud, the status of the absorbent garment based on the sensor data remaining consistent for a measured period of time; and
generating an action to limit wetness exposure time in the absorbent garment based on the status of the absorbent garment.

2. The cloud-implemented method of claim 1, wherein the sensor data, including the one or more events associated with the status of the absorbent garment, includes an event based on a change in the connection or circuit of the sensor system, and wherein providing sensor data further comprises:
verifying, within the sensor system, the sensor data of the absorbent garment by determining the one or more events associated with the status are consistent over a predetermined period of time;
modifying the sensor data to include identifying information; and
transmitting the sensor data, including the status of the absorbent garment, to the sensor cloud.

3. The cloud-implemented method of claim 1, wherein the status comprises at least one of: a confirmed event, a condition assigned before receiving the sensor data, an event associated with a wet or dry condition of the absorbent garment, an absorbent garment connection or disconnection event, a time of an event, a zone of wetness, or a patient identifier.

4. The cloud-implemented method of claim 3, wherein the wet or dry condition of the absorbent garment includes a priority level based on the time of the confirmed event and the zone of wetness sensed within the sensor system.

5. The cloud-implemented method of claim 4, wherein the zone of wetness includes at least one of a central zone or a perimeter zone.

6. The cloud-implemented method of claim 1, wherein validating the status of the absorbent garment further comprises:
determining the status of the absorbent garment is confirmed based on consistent sensor data readings for a measured period of time;
generating absorbent garment information based on a confirmed status;
transmitting absorbent garment information to a visual display; and
storing at least one event of the one or more events from the sensor data associated with the status of the absorbent garment.

7. The cloud-implemented method of claim 6, wherein validating the status of the absorbent garment further comprises:
receiving an inconsistent sensor data reading within the measured period of time; and
resetting the measured period of time without transmitting the absorbent garment information based on the inconsistent sensor data reading.

8. The cloud-implemented method of claim 1, wherein generating an action to limit wetness exposure time in the absorbent garment further comprises:
receiving absorbent garment information on a visual display,
wherein the visual display includes information about a product type, the status of the absorbent garment, a priority level based on time elapsed and a zone of wetness, user settings, training materials, and technical support; and
preparing an alert based on a priority level of the status.

9. The cloud-implemented method of claim 1, further comprising:
creating a sensor system database;
associating a user to the sensor system;
storing sensor data associated with one or more validated statuses related to the absorbent garment; and
comparing the data associated with the one or more validated statuses to create a history profile.

10. A wetness detection system for limiting wetness exposure time in an absorbent garment, the system comprising:
(a) a sensor system including one or more sensors, one or more absorbent garments, and one or more processors, the sensor system configured to:
(i) transmit sensor data associated with at least one of the one or more absorbent garments having one or more sensors;
(b) a sensor cloud in communication with the sensor system configured to:
(i) receive sensor data associated with the one or more sensors, wherein the sensor data includes one or more events determined by a connection and an open or closed circuit in a sensor of the one or more sensors to provide a status of the absorbent garment, and wherein the sensor data includes one or more attributes;
(ii) authenticate, in response to receiving the sensor data, at least one attribute of the one or more attributes by correlating the at least one attribute to data in the sensor cloud;
(iii) validate the status of the absorbent garment based on the sensor data remaining consistent for a measured period of time; and
(c) a monitoring system in communication with the sensor cloud, configured to:
(i) generate an action to limit wetness exposure time in the absorbent garment based on a priority level of the status of the absorbent garment.

11. The wetness detection system of claim 10, wherein the sensor data including the one or more events associated with the status of the absorbent garment includes an event based on a change in the connection or circuit of the sensor system, and wherein the sensor system is further configured to provide the sensor data by:
verifying the sensor data of the absorbent garment by determining the one or more events associated with the status are consistent over a predetermined period of time.

12. The wetness detection system of claim 11, wherein the sensor system is further configured to validate the status of the absorbent garment by:
determining the status of the absorbent garment is confirmed for the predetermined period of time;
modifying the sensor data to include identifying information;
sending the sensor data including the status of the absorbent garment after determining the status of the absorbent garment is confirmed; and
storing at least one event of the one or more events from the sensor data associated with the status of the absorbent garment.

13. The wetness detection system of claim 10, wherein the sensor cloud is further configured to generate an action to limit wetness exposure time in the absorbent garment by:
receiving absorbent garment information on a visual display,
wherein the visual display includes information about a product type, the status of the absorbent garment, the priority level based on time elapsed and a zone of wetness, user settings, training materials, and technical support; and
preparing an alert based on the priority level of the status.

14. The wetness detection system of claim 10, wherein the status comprises at least one of: a confirmed event, a condition assigned before receiving the sensor data, an event associated with a wet or dry condition of the absorbent garment, an absorbent garment connection or disconnection event, a time of an event, a zone of wetness, or a patient identifier.

15. The wetness detection system of claim 14, wherein the wet or dry condition of the absorbent garment includes the priority level based on the time of the confirmed event and the zone of wetness sensed within the sensor system.

16. The wetness detection system of claim 15, wherein the zone of wetness includes at least one of a central zone or a perimeter zone.

17. The wetness detection system of claim 14, wherein the sensor cloud is further configured to:
create a sensor system database;
associate a user to the sensor system;
store sensor data associated with one or more validated statuses related to the absorbent garment; and
compare the data associated with the one or more validated statuses to create a history profile.

18. The wetness detection system of claim 10, wherein the sensor cloud is further configured to validate the status of the absorbent garment by:
receiving an inconsistent sensor data reading within the measured period of time; and
resetting the measured period of time without transmitting the absorbent garment information based on the inconsistent sensor data reading.

19. A computer program product comprising at least one non-transitory computer-readable medium including program instructions that, when executed by at least one processor, cause the at least one processor to:
receive sensor data associated with one or more sensors associated with one or more absorbent garments, wherein the sensor data includes one or more events determined by a connection and an open or closed circuit in a sensor of the one or more sensors to provide a status of the one or more absorbent garments, and wherein the sensor data includes one or more attributes;
authenticate, by a sensor cloud in response to receiving the sensor data, at least one attribute of the one or more attributes by correlating the at least one attribute to data in the sensor cloud;
validate, by the sensor cloud, the status of the one or more absorbent garments based on the sensor data remaining consistent for a measured period of time; and
generate an action to limit wetness exposure time in the one or more absorbent garments based on the status of the one or more absorbent garments.

20. The computer program product of claim 19, further comprising program instructions that, when executed by the at least one processor, cause the at least one processor to generate the action to limit wetness exposure time in the absorbent garment by:
receiving absorbent garment information on a visual display,
wherein the visual display includes information about a product type, the status of the absorbent garment, a priority level based on time elapsed and a zone of wetness, user settings, training materials, and technical support; and
preparing an alert based on the priority level of the status.
